(19) United States
(12) Patent Application Publication
(10) Pub. No.: US 2015/0189334 A1
(43) Pub. Date: Jul. 2, 2015

(54) METHOD FOR SECURING A DVB-S2 TRANSMISSION

(71) Applicant: THALES, NEUILLY-SUR-SEINE (FR)

(72) Inventors: Katy GOURLAOUEN, GENNEVILLIERS CEDEX (FR); Lucie CHICHE, GENNEVILLIERS CEDEX (FR); Marc TOURET, GENNEVILLIERS CEDEX (FR)

(21) Appl. No.: 14/586,530

(22) Filed: Dec. 30, 2014

(30) Foreign Application Priority Data
Dec. 31, 2013 (FR) 1303116

(51) Int. Cl. H04N 21/2347; H04N 21/61; H04N 21/647; H04N 21/2383

(52) U.S. Cl. CPC H04N 21/2347; H04N 21/2383; H04N 21/6143; H04N 21/64715

(57) ABSTRACT

A method for enciphering a DVB-S2 frame or super-frame, including at least a first type of frame modulated with a first modulation M₁ and a second type of frame modulated with a second modulation M₂, comprises at least the following steps: inserting into the DVB-S2 super-frame a number of dummy frames “n” of DVB-S2 structure of length n in order to obtain a structure ST of the same defined duration T, for several given configurations, the size of the dummy frame “n” is defined in the field 29 of the code word of the PLS of a DVB-S2 frame, a dummy frame “n” being composed of a PLHeader and of n−1 slots of 90 complex symbols; and applying an enciphering algorithm to the super-frame thus obtained.

### CROSS-REFERENCE TO RELATED APPLICATION

This application claims priority to foreign French patent application No. FR 1303116, filed on Dec. 31, 2013, the disclosure of which is incorporated by reference in its entirety.

### FIELD OF THE INVENTION

The subject of the invention relates to a method for securing DVB-S2 transmissions (ETSI EN 302 307 standard, available on the ETSI website), notably by defining a TRANSEC mode enciphering all the DVB-S2 symbols, including the “PLHeader” header.

### BACKGROUND

The DVB-S2 standard was developed for very high speed civil applications, for example for television broadcasting. Once configured, a DVB-S2 carrier operates with a fixed symbol tempo, i.e. a fixed passband. The only possible adaptation is to change frame by frame the modulation and coding or MODCOD pair, which makes it possible to resist changes in propagation conditions with a dynamic swing of above 15 dB. This ACM (Adaptive Coding & Modulation) is intrinsic to the standard, but requires a return channel to inform the DVB-S2 sender of the propagation conditions seen by the receiver. MODCODs may differ from one frame to the next and so the spectral efficiency may too. However, in DVB-S2, a frame always transports 64800 bits, and it does so independently of the MODCOD pair used. Table I below indicates for “normal” frames (FECFRAME of 64800 bits), the number of symbols following modulation and the presence or absence of a pilot symbol:

TABLE I

| | Pilotless | With Pilot |
|---|---|---|
| QPSK | 32490 | 33282 |
| 8 PSK | 21690 | 22194 |
| 16 APSK | 16290 | 16686 |

The result is that a DVB-S2 frame does not have a fixed number of symbols and therefore a fixed duration. This absence of temporal synchronicity prevents the implementation of efficient techniques for securing transmission (TRANSEC), signalling (NETSEC), or communication (COMSEC). Indeed, a frame S2 cannot be enciphered as a function of an implicit marker such as its number or the time, because of its aperiodic structure. The receiver cannot know:
how many S2 frames have been sent and therefore the current frame number, or
the time of the frame, a time generally used to initialize the security or enciphering elements.
   Consequently, techniques for securing DVB-S2 TRANSEC transmissions require the transmission in clear form of the enciphering marker and the header of the physical frame, which leads to the possibility of the stream being analyzed by an unauthorized third party.

The prior art known to the Applicant does not describe how to encipher a DVB-S2 frame on a synchronous mode. Various systems exist for enciphering a part of the frame only. The header of the physical frame is then passed in clear form and sometimes with the time marker. There is also a TRANSEC option for DVB-S2, but this TRANSEC is actually only a COMSEC because it does not protect from interception, or from scrambling.

FIG. 1A represents an example of a system of the prior art for enciphering a DVB-S2 frame. The system comprises a first device 1 comprising an enciphering module 2 at the DVB-S2 demodulator, 3, or arranged in front of it, which will use a key K that is generated by a key management system 10, to secure the contents of the information to be transmitted, for example an IP internet stream shaped by an “encapsulation” mode, 4, for example a GSE (Generic Stream Encapsulation) mode known to those skilled in the art, and to make it invisible. The reception device 5 comprises a deciphering module 6 located at the demodulator DVB-S2, 7, which uses the same key or a derivative of the key K, to transform the enciphered content and allow its reading after, for example, having de-encapsulated 8 the data. The generation of keys K is carried out using a key generator, for example, and the keys are communicated to the deciphering module 6 and/or to the enciphering module 2 via the key management system 10. The decipherer is authorized to receive the contents of the information only it if receives the key being used. The enciphering is applied over the data field of the BB frame (cf. BBFRAME defined in the aforementioned EN 302 307 standard). The enciphering is applied only over the data field of the BB frame because in general the header BBheader contains signalling information relating to the enciphering algorithm (the key number for example). Consequently, TRANSEC techniques require the transmission in clear form of the BB frame headers (BBFRAME) and also that of the physical frame (PLHEADER).

FIG. 1B represents a frame DVB-S2 comprising a BBheader on 80 bits followed by a data field.

FIG. 2 gives an example of a block enciphering technique known from the prior art. The data field in the BB frame will be enciphered using an AES-CBC (Advanced-Encryption-Standard-Cipher-Block-Chaining) enciphering mode as illustrated, with on-the-fly text enciphering or cyphertext sealing (CBC-CS). The first data block to be entered into the enciphering algorithm 2 is composed of the first 128 bits of the data field.

Most of the systems described in the prior art have a low level of security, with analysis of the traffic being possible by reading the headers transmitted in clear form, and easier scrambling due to the temporal position of the header being known. Indeed, it is enough to scramble this part for the rest of the signal to be unusable.

There is therefore a need for a method making it possible to secure the entire DVB-S2 frame, headers (PLHEADER and BBHEADER) and data included, in order to avoid the problems of poor security encountered in systems of the prior art.

In the remainder of the description, the following definitions will be used:
a super-frame ST is composed of several DVB-S2 frames for one configuration, the frames being able to be modulated with different modulations,
a dummy frame “n” is an extension of the dummy DVB-S2 frame defined in section 5.5.1 of the aforementioned document EN 302 307. This denotes a mute frame, used when there are no data to transmit or to temporally complete DVB-S2 super-frames. A dummy frame “n” is composed of a PLHEADER (cf. 5.5.2 EN 302 307) adapted for the synchronization and signalling of the physical layer PLS and of n−1 slots of 90 complex symbols (I=(1/√2), Q=(1/√2)),
the dummy frame “37” is identical to the dummy frame defined in section 5.5.1 of the document EN 302 307,
the insertion of a dummy frame “n” and a dummy frame “p” is equivalent in the number of symbols to the insertion of a dummy frame “n+p”,
the word “slot” defines a set of 90 symbols,
PSK corresponds to a phase shift modulation, QPSK to a modulation with four possible phase values (or quadrature phase shift keying).

### SUMMARY OF THE INVENTION

One of the aims of the present invention is to propose a method making it possible to construct a DVB-S2 super-frame of fixed duration in order to be able to define a TRANSEC mode adapted for enciphering all the DVB-S2 symbols, including the header or PLheader. The definition of a new temporal structure must notably meet the following requirement: the structure of the DVB-S2 frames must not be modified, so as to have a minimal effect on the standard, and consequently on the existing technological DVB-S2 building blocks.

If one wishes to define a period structure for a DVB-S2 carrier and implement the TRANSEC over all the symbols of the frame in the physical layer PLFrame (Physical Layer Frame), it is necessary to define a structure allowing all types of DVB-S2 frame.

The invention relates to a method for enciphering a DVB-S2 frame or super-frame including at least a first type of frame modulated with a first modulation M₁ and a second type of frame modulated with a second modulation M₂, characterized in that it comprises at least the following steps:
inserting into the DVB-S2 super-frame a number of dummy frames “n” of DVB-S2 structure of length n in order to obtain a structure ST of the same defined duration T, for several given configurations, the size of the dummy frame “n” is defined in the field 29 of the code word of the PLS of a DVB-S2 frame, a dummy frame “n” being composed of a PLHeader and of n−1 slots of 90 complex symbols,
applying an enciphering algorithm to the super-frame thus obtained.

In a variant embodiment a super-frame ST comprises a number a of frames modulated with a first modulation M₁, b frames modulated with a second modulation M₂, and c frames modulated with a k^{th} modulation Mₖ, and x dummy frames “n” of length n are introduced for the frames of modulation M₁, y dummy frames “p” of length p are introduced for the frames of modulation M₂, and z dummy frames “q” of length q are introduced for the frames of modulation Mₖ, in order to obtain a given length of super-frame T whatever the modulations used for several configurations.

A super-frame is, for example, composed of a QPSK frames and b 8PSK frames, and a number x of dummy frames “n” of length n and a number y of dummy frames “n−1” of length n+1 are introduced in order for the length of the super-frame ST to correspond to a given length or length of time T.

In the case where the super-frame is composed of 10 QPSK frames with pilots and 15 8PSK frames with pilots, a dummy frame “1” of a length of 1 slot is introduced for the QPSK frame.

In a variant, it is possible to distribute the dummy frames “n” regularly in the super-frame.

In another variant, a single dummy frame “n” is introduced at the end of the super-frame, according to the principle mentioned previously “n”+“p”=“n+p”.

In a variant embodiment, the type of dummy frame “n” to be introduced is determined according to the frame type, frame with pilot or pilotless frame.

The PLS signalling comprising the modulation, encoding and type features of a frame can be modified to indicate the size “n” of a dummy frame “n” and a type 00 (dummy frame “1”) corresponding to one slot to align the pilotless frames, a type 01 (dummy frame “2”) having two slots, a type 10 (dummy frame “9”) of 9 slots and a type 11 (dummy frame “10”) of 10 slots to align the types of frames with pilots are defined.

For example, a dummy frame “n” is introduced at the start of the super-frame ST in order to facilitate synchronization.

According to one embodiment of the method, super-frames ST are constructed having a duration of a few hundred ms, 250 ms.

### BRIEF DESCRIPTION OF THE DRAWINGS

Other features and advantages of the device according to the invention will become more apparent on reading the following description of exemplary embodiments, given for the purposes of illustration and without being in any way limiting, appended with figures representing:

FIG. 1A and FIG. 1B, a transmission security solution of the prior art,

FIG. 2, another example of enciphering with the AES mode,

FIG. 3, a diagram of the implementation of the method according to the invention,

FIG. 4, an example of a configuration for multi-ACM super-frames, and

FIG. 5, a reminder of the possible values of the PLS (Physical Layer Signalling) of the DVB-S2 standard.

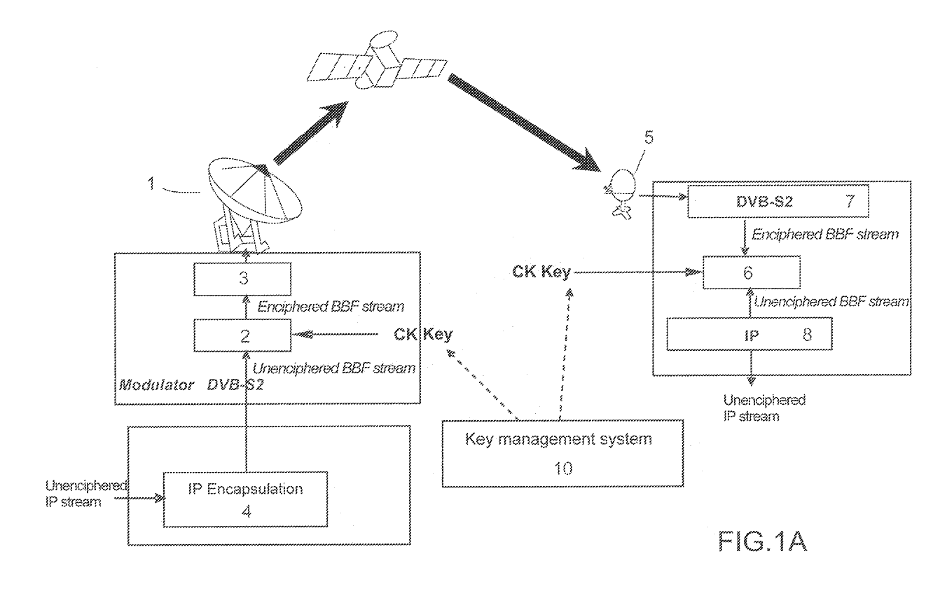

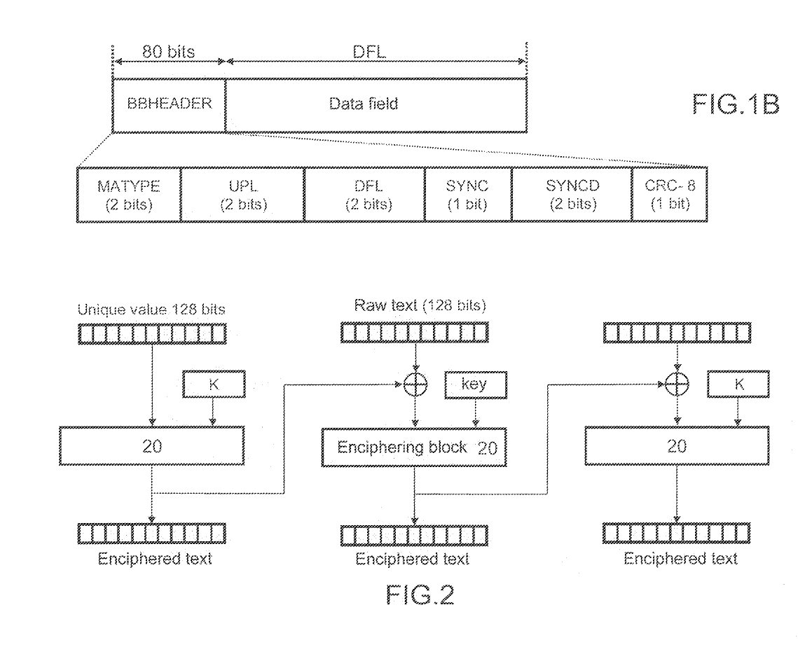

### DETAILED DESCRIPTION

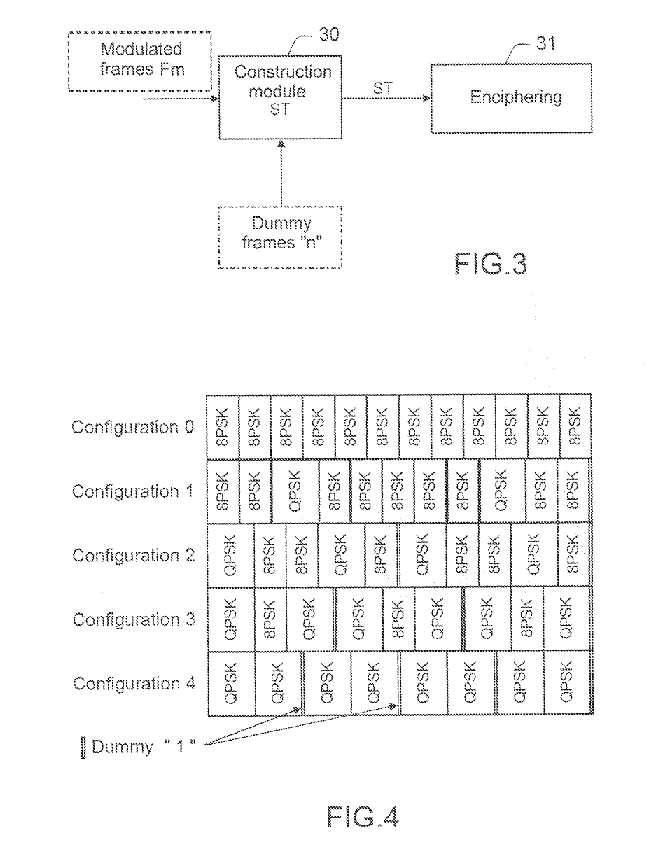

FIG. 3 is a diagram of an example of a system enabling the implementation of the method according to the invention. The system comprises a module 30 for defining or constructing a super-frame ST receiving the DVB-S2 frames modulated at a frequency Fm. The definition and construction module 30 is adapted for defining the size n of the dummy frame “n” to be added to obtain a super-frame ST of fixed duration by executing the steps of the method detailed hereinafter, an enciphering module 31 receiving the super-frames thus generated.

To be able to define a DVB-S2 TRANSEC, the method determines a temporal structure called the super-frame ST which exhibits a fixed length of time T for several configurations and for a band B of the system. The defined super-frame will be compliant with the structure of a DVB-S2 frame. Its duration T_{ST} is for example in the order of a few milliseconds, less than 500 ms, for example, in order to allow rapid synchronization, and its duration will also be chosen as a function of the ACM modulation mechanisms. The ACM mechanisms must indeed be able to be applied at a faster tempo than the super-frame. The super-frame is composed of several DVB-S2 frames for a given configuration, and a DVB-S2 frame is modulated with a given modulation, for example QPSK or 8 PSK.

“Normal” DVB-S2 frames are of different lengths depending on the type of modulation:
a QPSK frame is made up of 361 slots of 90 symbols,
an 8 PSK frame is made of up 241 slots of 90 symbols (same symbol speed as QPSK because the band is fixed).
   The numbers 361 and 241 being mutually prime, the temporal alignment of the frames will be carried out using dummy frames “n” as will be explained hereinafter.

In the DVB-S2 standard, the dummy frames (dummy frame “37” of the present invention) have no real use unless it is to send stuffing. The method will use dummy frames existing in the standard, while modifying their length, and the new length will be indicated in the PLHeader header. The receiver terminal will not need to know in advance the size n of the dummy frames “n” because this item of information, in this case “n”, will be indicated in the PLHeader.

The method will proceed, for example, in the following manner. Let T be the length of time that an ST super-frame must observe, a super-frame being defined for a band B of the system. Let a be the number of frames modulated with QPSK modulation and b the number of frames modulated with 8 PSK modulation, for example. The method will introduce regularly, for example, several dummy frames “1” in order for the super-frame ST to always preserve the same length for all the desired configurations (modulation configurations). It is also possible to insert the dummy frame “1” at the end of the super-frame.

Table II below gives an example of configurations for multi-ACM QPSK/8PSK super-frames. According to the implementation of the method, frames having different modulations are combined within one and the same super-frame ST, in order to have an optimal multi-ACM.

TABLE II

| | | | | | |
|---|---|---|---|---|---|
| Multi-ACM configuration | 0 | 1 | 2 | 3 | 4 |

| | | | | | | |
|---|---|---|---|---|---|---|
| QPSK | Number of | 0 | 2 | 4 | 6 | 8 |
| | frames | | | | | |
| 8PSK | Number of | 12 | 9 | 6 | 3 | 0 |
| | frames | | | | | |
| dummy frame “n” | “n” | 0 | 1 | 2 | 3 | 4 |
| | Number of | | | | | |
| | slots | | | | | |
| | (including | | | | | |
| | header) | | | | | |

| | |
|---|---|
| Number of symbols | 260280 |

For each configuration, it is possible to compose the structure of the STs by uniformly distributing the frames of same modulation in order to limit jitter as illustrated in FIG. 4. The size n of the dummy frame “n” used to temporally complete an ST, in this example, is always the same, a “dummy” frame of a single slot reduced to the PLHeader. This dummy frame “1” is repeated according to the ACM configurations. The result is a temporal alignment of the super-frames for all multi-ACM configurations from 0 to 4.

The method relies on the possibility of transmitting as many dummy slots as the ST structure requires. An extensive use of the PLS signalling included in the PLHeader of the DVB-S2 frame would make it possible to indicate to the receiver the size n of the current dummy frame “n”.

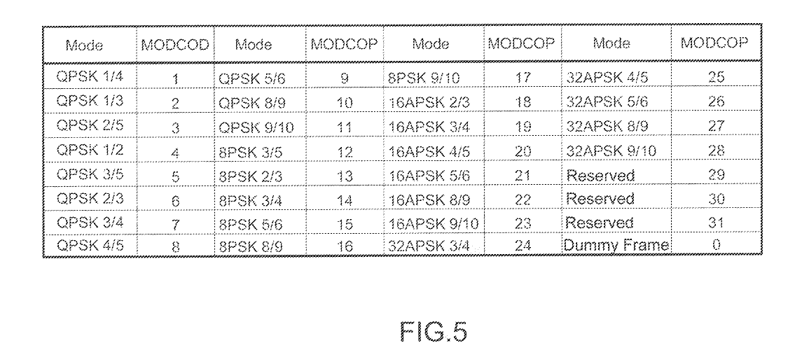

FIG. 5 is a reminder of PLS signalling. The PLS is composed of two fields:
MODCOD (5 bits) which identifies the modulation and the code rate of the frame,
TYPE (2 bits) which identifies the type of frame (normal/short) and the presence/absence of pilot symbols, an insignificant field for a DVB-S2 “dummy” frame defined in the document EN 302 307.
   The MODCOD field has three reserved values as well as a fourth for indicating that the frame is a conventional “dummy” (dummy frame “37” of the present invention). These three values combined with the TYPE field make it possible to define 12 sizes of dummy frame “n” in addition to the conventional “dummy” frame.

In the prior art, a DVB-S2 receiver can decode any DVB-S2 carrier, without a priori knowledge of the modulation and the encoding of the carrier, since each frame indicates its features (MODCOD, TYPE) via the PLS. The method according to the invention will preserve this property.

Table III below gives an example for modifying the PLS field according to the steps of the method.

TABLE III

| | | | “n” | |
|---|---|---|---|---|
| | | | Number | |
| | | | of slots | |
| | | | (including | |
| Mode | MODCOD | TYPE | header) | |
| dummy frame “n” | 29 | 00 | 1 | To align |
| | | 01 | 2 | pilotless |
| | | | | frames |
| | | 10 | 9 | To align |
| | | 11 | 10 | frames with |
| | | | | pilots |
| “conventional” | 0 | — | 37 | |
| dummy | | | | |

In this example four types of dummy frames “n” are defined in the field 29 of MODCOD. Types 00 and 01 will be used to align pilotless frames. In this example, TYPE 00 corresponds to one slot (PLHEADER alone), TYPE 01 to 2 slots including the slot of the header in the case of pilotless frames. The types 10 and 11 are reserved for pilotless frames. TYPE 10 corresponds to adding 9 slots and TYPE 11 to adding 10 slots to align pilotless frames.

Table IV below gives an example of the type of “dummy” frame that is required to complete super-frames composed of frames of the same modulation in a system that only requires pilotless frames, typically a fixed system with equipment with low phase noise. The example is given for a super-frame the modulation of which is at best 16 APSK modulation.

TABLE IV

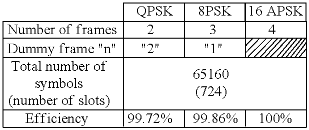

For 16 APSK modulation, no dummy frame is introduced into the super-frame, for 8PSK modulation, dummy frames “1” are introduced, and for QPSK modulation, dummy frames “2” are introduced. In general, it is possible to write for a predetermined value n, that dummy frames of length n, n−1, n+2 with n=0 for 16 APSK, 8PSK, and QPSK modulation respectively are introduced.

With ACM systems, “pilot” symbols can be inserted into the physical layer frame structure to facilitate the synchronization and also for channel estimation purposes. At the demodulator, with the specified phase noise, the phase recuperation appears very difficult without a pilot for 8 PSK and higher-order modulations. Moreover, in the ACM system, a receiver is generally capable of decoding a part of the total stream only, and more precisely only the sent frames whose MODCO are compatibles with the conditions of the user channel. In this context, the pilot symbols also allow the recovery of carriers without knowledge of frame data, even in cases where certain PLHeaders are not correctly decoded, because the pilots are regularly spaced.

The principle disclosed above is applicable to frames with a pilot. However, the number of pilot symbols per frame is not multiple of 90:
22 blocks of 36 symbols in QPSK,
14 blocks of 36 symbols in 8PSK,
11 blocks of 36 symbols in 16ASPK.

To have a multiple of 90 symbols per super-frame, a minimum of 5 frames with pilot is required (5*36=2*90= . . . ).

By applying the rules given for a system which only requires frames with pilots, the size n of the dummy frame “n” that is necessary to complete the super-frames is deduced therefrom.

The following Table V gives an example of a type of “dummy” frame that will be used to complete the super-frame.

TABLE V

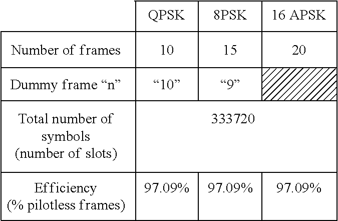

An ST with a pilot therefore requires more symbols than a pilotless ST. In order not to affect the ACM functionality inherent to the DVB-S2, it is preferable to have an ST in the order of a few 100 ms (typically 250 ms).

For an ST with a pilot of 250 ms this enforces a minimum bitrate of 1.33 Mbauds.

For mobile applications, 16 APSK modulations will not be used. The structure of the ST can therefore be optimized by reducing the size of the “dummy” frames by additions as indicated in Table VI below:

TABLE VI

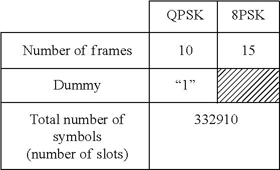

The introduction of a dummy frame “n” of variable size n makes it possible to structure a DVB-S2 carrier in a super-frame of fixed duration and thus to implement a TRANSEC with an implicit marker based on the time or the number of the ST for example.

### ADVANTAGES

The method according to the invention notably increases the security of the transmissions, and resistance to interception. It allows temporal alignment of a super-frame ST2 and makes it possible to add time markers to the DVB-S2 structure and consequently to implicitly define an initial enciphering vector. The “n” modified dummy frames have no effect on the DVB-S2 standard. The invention makes it possible to encipher the whole DVB-S2 frame.

1. A method for enciphering a DVB-S2 frame or super-frame including at least a first type of frame modulated with a first modulation M₁ and a second type of frame modulated with a second modulation M₂, comprising at least the following steps:
inserting into the DVB-S2 super-frame a number of dummy frames “n” of DVB-S2 structure of length n in order to obtain a structure ST of the same defined duration T, for several given configurations, the size of the dummy frame “n” is defined in the field 29 of the code word of the PLS of a DVB-S2 frame, a dummy frame “n” being composed of a PLHeader and of n−1 slots of 90 complex symbols, and
applying an enciphering algorithm to the super-frame thus obtained.

2. The method according to claim 1, wherein the super-frame comprises, a frames modulated with a first modulation M₁, b frames modulated with a second modulation M₂, and c frames modulated with a k^{th} modulation Mₖ, and in that x dummy frames “n” of length n are introduced for the frames of modulation M₁, y dummy frames “p” of length p are introduced for the frames of modulation M₂, and z dummy frames “q” of length q are introduced for the frames of modulation Mₖ, in order to obtain a given length of super-frame T whatever the modulations used for several configurations.

3. The method according to claim 1, wherein the super-frame is composed of a QPSK frames and b 8PSK frames and in that a number x of dummy frames “n” of length n and a number y of dummy frames “n+1” of length n+1 are introduced in order for the length of the super-frame ST to correspond to a given length or length of time T.

4. The method according to claim 3, wherein for a super-frame composed of 10 QPSK frames with pilots and 15, 8PSK frames with pilots, a dummy frame “1” of a length of 1 slot is introduced for the QPSK frame.

5. The method according to claim 1, wherein the dummy frames “n” are distributed regularly in the super-frame.

6. The method according to claim 1, wherein a single dummy frame “n” is introduced at the end of the super-frame.

7. The method according to claim 1, wherein the type of dummy frame “n” to be introduced is determined according to the frame type, frame with a pilot or pilotless frame.

8. The method according to claim 3, wherein the PLS signalling comprising the modulation, encoding and type features of a frame are modified to indicate the size “n” of a dummy frame “n” and a type 00 (dummy frame “1”) corresponding to one slot to align the pilotless frames, a type 01 (dummy frame “2”) having two slots, a type 10 (dummy frame “9”) of 9 slots and a type 11 (dummy frame “10”) of 10 slots to align the types of frames with pilots are defined.

9. The method according to claim 1, wherein a dummy frame “n” is introduced at the start of the super-frame ST in order to facilitate synchronization.

10. The method according to claim 1, wherein super-frames ST are constructed having a duration of a few hundred ms, 250 ms.
